(19) United States
(12) Patent Application Publication
(10) Pub. No.: US 2012/0271830 A1
(43) Pub. Date: Oct. 25, 2012

(54) DATA PROCESSING DEVICE

(76) Inventors: Tomohiro Shiino, Tokyo (JP); Yoko Sano, Tokyo (JP); Tsuyoshi Sempuku, Tokyo (JP); Hideto Miyazaki, Tokyo (JP); Kuniyo Ieda, Tokyo (JP); Takashi Sadahiro, Tokyo (JP); Shoji Tanaka, Tokyo (JP)

(21) Appl. No.: 13/516,438

(22) PCT Filed: Dec. 16, 2009
(86) PCT No.: PCT/JP2009/006925

§ 371 Date: Jun. 15, 2012

(51) Int. Cl. G06F 17/30

(52) U.S. Cl. 707/740; 707/E17.089

(57) ABSTRACT

Disclosed is a data processing device including a data acquisition unit for acquiring data from a medium, an integrated database for integrating the data acquired by the data acquisition unit thereinto, a data analysis determination unit for analyzing the data integrated into the integrated database, a display control unit for creating an image of a side view of and an image of a bottom view of a solid expressing the data integrated into the integrated database on the basis of an analysis result acquired by the data analysis determination unit and the data, and a display unit for displaying the images created by the display control unit.

### FIELD OF THE INVENTION

The present invention relates to a data processing device which plainly displays data stored in as medium when this medium is connected to a playback device.

### BACKGROUND OF THE INVENTION

In recent years, a playback device suitable for use in searching for a desired musical piece has been known. This playback device is used as a recording medium playback device which records music data contained in a plurality of CDs (Compact Discs) or music data downloaded from the Internet into a hard disk, and plays back music data recorded in the hard disk. For example, patent reference 1 discloses a playback device which enables the user to manage desired musical pieces in desired discs more intuitively in a case in which music data contained in a plurality of discs are recorded into a hard disk.

In this playback device, music data recorded in a plurality of CDs are recorded into the hard disk. When playing back music data recorded in this hard disk, the playback device produces a display of an image in which objects each having a substantially square-shaped cross section and shaped like a thin plate are arranged horizontally while being stood up as if a plurality of CD jackets were arranged in a rack. By operating this image by using a mouse, the user can move the position where to flip through the pages of this display one by one toward the right or the left. As a result, the user can search for desired music data to cause the playback device to play back the desire music data as if the user searched for a desired CD jacket while flipping through the CD jackets in the rack.

### RELATED ART DOCUMENT

### Patent Reference

Patent reference 1: Japanese Unexamined Patent Application Publication No. 2009-80934

While the above-mentioned conventional playback device can manage desired musical pieces contained in desired discs more intuitively in a case in which music data contained in a plurality of discs are recorded into a hard disk, for example, there is a demand to develop a technique capable of displaying data stored in a disc more plainly while further improving the ease of use.

The present invention is made in order to meet the above-mentioned demand, and it is therefore an object of the present invention to provide a data processing device which can display data stored therein more plainly.

### SUMMARY OF THE INVENTION

In accordance with the present invention, there is provided a data processing device including: a data acquisition unit for acquiring data from a medium; an integrated database for integrating the data acquired by the data acquisition unit thereinto; a data analysis determination unit for analyzing the data integrated into the integrated database; a display control unit for creating an image of a side view of and an image of a bottom view of a solid expressing the data integrated into the integrated database on the basis of an analysis result acquired by the data analysis determination unit and the data; and a display unit for displaying the images created by the display control unit.

Because the data processing device in accordance with the present invention is constructed in such away as to create and display an image of a side view of and an image of a bottom view of a solid expressing data integrated into the integrated database, the data processing device can plainly display the data stored therein.

### BRIEF DESCRIPTION OF THE FIGURES

FIG. 1 is a view for explaining the expression of data in a data processing device in accordance with the present invention;

FIG. 2 is a view for explaining cylinders used in order to express data in the data processing device in accordance with the present invention;

FIG. 3 is a block diagram showing the structure of a data processing device in accordance with Embodiment 1 of the present invention;

FIG. 4 is a flow chart showing the operation of the data processing device in accordance with Embodiment 1 of the present invention;

FIG. 5 is a view showing an example of a table of a data set for use in the data processing device in accordance with Embodiment 1 of the present invention;

FIG. 6 is a view showing a display example of a side view and a bottom view displayed by the data processing device in accordance with Embodiment 1 of the present invention;

FIG. 7 is a view showing an example of grouping musical pieces into some groups each having “related” musical pieces which resemble each other to display them in the data processing device in accordance with Embodiment 1 of the present invention;

FIG. 8 is a view showing a display example which enables a more efficient operation in the data processing device in accordance with Embodiment 1 of the present invention;

FIG. 9 is a view for explaining an operation of excluding a medium and an operation of returning a medium on a side view displayed by the data processing device in accordance with Embodiment 1 of the present invention;

FIG. 10 is a view for explaining an operation of excluding a medium and an operation of returning a medium on a bottom view displayed by the data processing device in accordance with Embodiment 1 of the present invention;

FIG. 11 is a view showing a display example of a side view and a bottom view displayed by a data processing device in accordance with Embodiment 2 of the present invention;

FIG. 12 is a view showing a display example of a side view and a bottom view displayed by a data processing device in accordance with Embodiment 3 of the present invention;

FIG. 13 is a view showing a display example of a side view and a bottom view displayed by a data processing device in accordance with Embodiment 4 of the present invention;

FIG. 14 is a view showing a display example of a side view and a bottom view displayed by a data processing device in accordance with Embodiment 5 of the present invention;

FIG. 15 is a view showing a display example in a case of using cones in order to express data in the data processing device in accordance with any one of Embodiments 1 to 5 of the present invention; and

FIG. 16 is a view showing a display example in a case of using solid spheres in order to express data in the data processing device in accordance with any one of Embodiments 1 to 5 of the present invention.

### EMBODIMENTS OF THE INVENTION

Hereafter, music data, static image data such as photographs, video data, POI (Point Of Interest) data, and so on are generically referred to as “data”. Further, equipment and a medium which can accumulate and store data, e.g., an SD card, a DAP (Digital Audio Player), or a USB memory are generically referred to as a “medium”, and this medium includes a server connected to a network and an HDD (Hard Disc Drive). In addition, equipment which can read data, and play back or edit the data is generically referred to as a “playback device”.

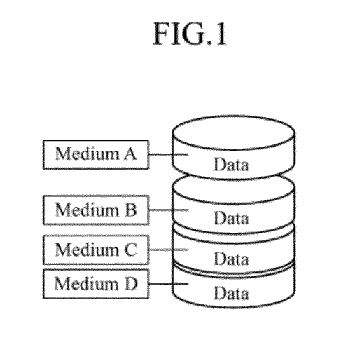

A data processing device in accordance with the present invention switches between two types of views to express data. For example, as shown in FIG. 1, the data processing device likens each medium to one solid (e.g. a cylinder) to express data included in each medium. When a plurality of media exist, data included in these media are expressed as a state in which a plurality of cylinders are laminated. Instead of media, sets of other data, such as music albums, can be used, for example.

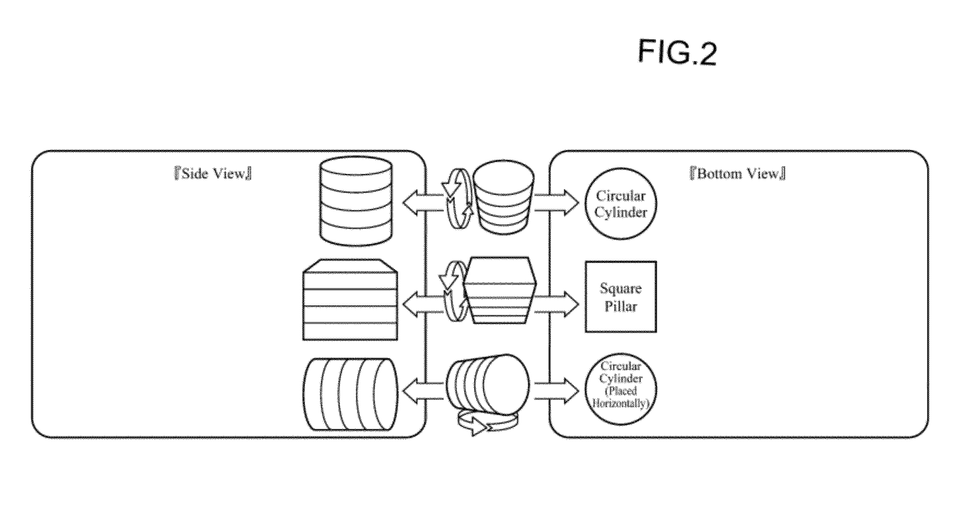

As each cylinder, a circular cylinder or a square pillar as shown in FIG. 2 can be used. Further, the axis of each cylinder can be oriented not only in a vertical direction, but also in a horizontal direction. Each cylinder is displayed in either of two views based on different concepts, as shown in FIG. 2. In this embodiment, one of the views which is seen from a side surface direction is referred to as a “side view”, and the other view which is seen from a bottom is referred to as a “bottom view”. The side view is used when displaying all the data included in the plurality of media individually on a per-medium basis. The bottom view is used in order to express similarities or relationships among the plurality of media regarding all the data included in the plurality of media.

Hereafter, the preferred embodiments of the present invention will be explained in detail with reference to the drawings.

### Embodiment 1

A data processing device in accordance with Embodiment 1 of the present invention expresses music data included in each of a plurality of media connected thereto by using a circular cylinder. More specifically, one circular cylinder shows one medium for storing music data, and a number of circular cylinders whose number is equal to the number of media connected to the data processing device are laminated and shown. In this specification, “music data” include, as well as data expressing sound sources to be played back (referred to as “sound source data” from here on), tag information (music title, artist name, performance time, data volume, age, and album name or genre) and user action history information (the number of playback times, the date and time at which each sound source was played back the last time, and so on).

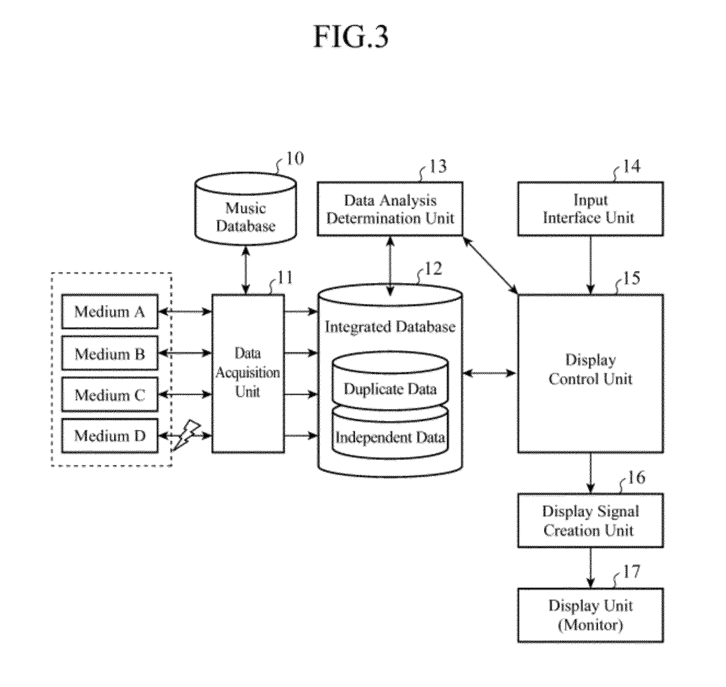

FIG. 3 is a block diagram showing the structure of the data processing device in accordance with Embodiment 1 of the present invention. This data processing device is provided with a music database 10, a data acquisition unit 11, an integrated database 12, a data analysis determination unit 13, an input interface unit 14, a display control unit 15, a display signal creation unit 16, and a display unit 17.

The music database 10 stores tag information. This music database 10 can be formed in a local area within the data processing device. As the music database 10, a database on the Internet can also be used.

The data acquisition unit 11 acquires sound source data from a plurality of media A to D connected to the data processing device, acquires tag information from the music database 10, and also acquires user action history information from the playback device (not shown), and sends the sound source data, the tag information, and the user action history information to the integrated database 12. Each of the plurality of media can be constructed in such a way as to be connected directly to the data processing device by using a connector or a cable. As an alternative, each of the plurality of media can be constructed in such a way as to be connected to the data processing device via communications using a radio, an infrared ray, or the like, like the medium D.

The integrated database 12 integrates the music data acquired by the data acquisition unit 11 thereinto. The contents of this integrated database 12 are accessed by the data analysis determination unit 13 and the display control unit 15. The data analysis determination unit 13 analyzes the music data stored in the integrated database 12 to construct a table of a data set (the details of the table will be mentioned below).

The input interface unit 14 receives a user command from, for example, a touch panel or a remote controller (both of them are not shown in the figure), and sends the user command to the display control unit 15. This command inputted from the input interface unit 14 includes a command for switching between views.

The display control unit 15 creates an image of a side view of and an image of a bottom view according to the music data from the integrated database 12 and the analysis result from the data analysis determination unit 13. An image created by the display control unit 15 is sent to the display signal creation unit 16 as display image data.

The display signal creation unit 16 creates a display signal according to the display image data sent thereto from the display control unit 15, and sends the display signal to the display unit 17. The display unit 17 is comprised of, for example, a monitor, and displays the image according to the display signal sent thereto from the display signal creation unit 16.

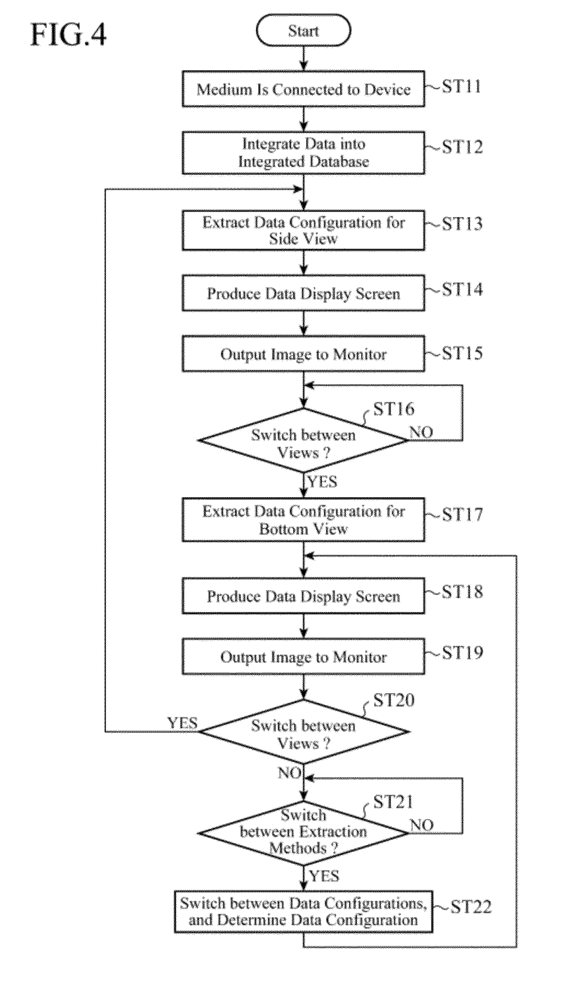

Next, the operation of the data processing device in accordance with Embodiment 1 of the present invention will be explained with reference to a flow chart shown in FIG. 4. First, a medium is connected to the data processing device (step ST11). More specifically, at least one medium is connected to the data acquisition unit 11 of the data processing device directly or via communications.

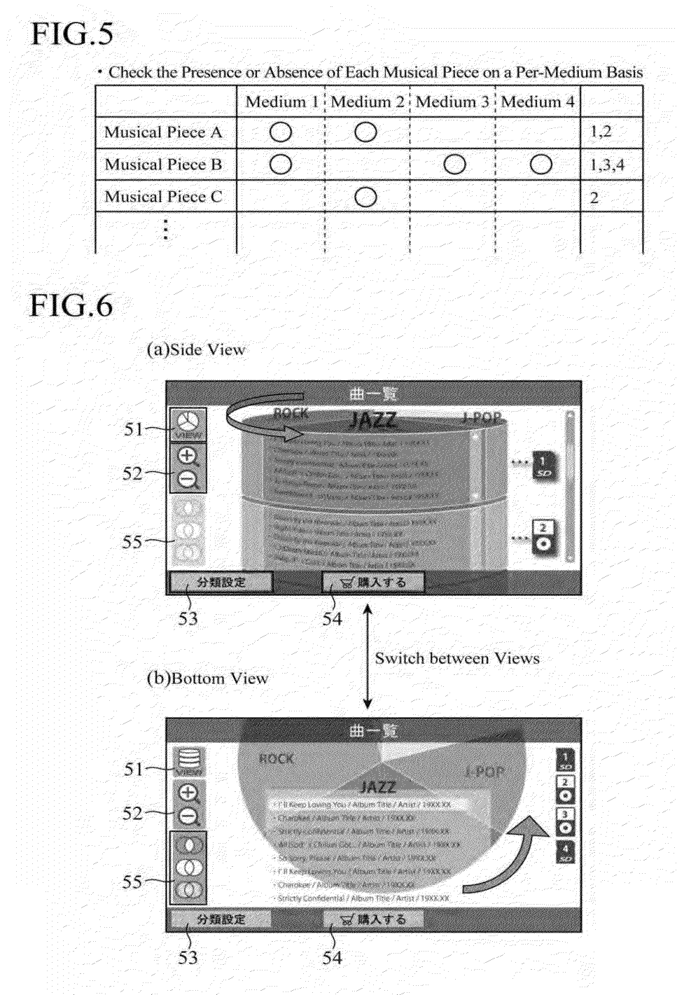

Then, music data are integrated into the integrated database (step ST12). More specifically, the data acquisition unit 11 acquires sound source data from each medium connected to the data processing device in step ST11, acquires tag information from the music database 10, and also acquires user action history information from the playback device (not shown), and sends the sound source data, the tag information, and the user action history information to the integrated database 12. As a result, the music medium included in each medium is integrated into the integrated database 12, and a table of a data set is constructed. For example, as shown in FIG. 5, while the presence or absence of each musical piece is checked for each medium, a degree of similarity is defined by integrating the metadata of musical pieces and calculating various vectors.

Then, extraction of a data configuration for side view is carried out (step ST13). More specifically, the data analysis determination unit 13 extracts data for side view from the music data which are integrated into the integrated database 12, and sends the data for side view to the display control unit 15 as data for display.

A data display screen is then produced (step ST14). More specifically, the display control unit 15 creates a display image of a side view according to both the music data sent thereto from the integrated database 12 and the analysis result sent thereto from the data analysis determination unit 13, and sends this display image to the display signal creation unit 16.

An output to the monitor is then carried out (step ST15). More specifically, the display unit 17 creates a display signal for displaying the image of the side view according to the display image sent thereto from the display signal creation unit 16 in step ST14, and sends the display signal to the display unit 17. As a result, the image of the side view is displayed on the screen of the display unit 17.

Whether or not a view switching command has been issued is then checked to see (step ST16). More specifically, the display control unit 15 checks to see whether or not a command of switching between views has been sent thereto from the input interface unit 14. When, in this step ST16, determining that a view switching command has not been issued thereto, the display control unit enters a standby state in which the display control unit repeatedly carries out this step ST16.

When it is determined that a view switching command has been issued in the state in which the display control unit is on standby while repeatedly carrying out step ST16, extraction of a data configuration for bottom view is then carried out (step ST17). More specifically, the data analysis determination unit 13 extracts data for bottom view from the data included only in one medium which are integrated into the integrated database 12, data included commonly in a plurality of media, or a combination of media commonly including data, and sends the data extracted thereby to the display control unit 15 as data for display.

A data display screen is then produced (step ST18). More specifically, the display control unit 15 creates a display image according to both the music data sent thereto from the integrated database 12 and the analysis result sent thereto from the data analysis determination unit 13, and sends the display image to the display signal creation unit 16.

An output to the monitor is then carried out (step ST19). More specifically, the display unit 17 creates a display signal for displaying the image of the bottom view according to the display image sent thereto from the display signal creation unit 16, and sends the display signal to the display unit 17. Accordingly, the image of the bottom view is displayed on the screen of the display unit 17.

Whether or not a view switching command has been issued is then checked to see (step ST20). More specifically, the display control unit 15 checks to see whether or not a command for switching between views has been issued from the input interface unit 14. When it is determined, in this step ST16, that a view switching command has been issued, the data processing device returns the sequence to step ST13 and repeats the above-mentioned processing.

In contrast, when it is determined, in step ST16, that a view switching command has not been issued, whether or not a command for switching between extraction methods has been issued is then checked to see (step ST21). More specifically, the display control unit 15 checks to see whether or not a command for switching between extraction methods has been sent thereto from the input interface unit 14. When it is determined, in this step ST21, that no command for switching between extraction methods has been issued, the display control unit enters a standby state in which the display control unit repeatedly carries out this step ST21.

When it is determined that a command for switching between extraction methods has been issued in the state in which the display control unit is on standby while repeatedly carrying out step ST21, switching between data configurations and determination of a data configuration are carried out (step ST22). Then, the data processing device returns the sequence to step ST18 and repeats the above-mentioned processing.

Next, some display examples each of which is displayed on the screen of the display unit 17 through the processing shown in the above-mentioned flow chart will be explained. FIG. 6(a) shows a display example of the side view, and FIG. 6(b) shows a display example of the bottom view. The side view is displayed in the form of a bird's-eye view in which laminated circular cylinders are viewed diagonally from above, and the bird's-eye angle can be determined arbitrarily. For example, the side view can be displayed in the form of a view which is viewed from just beside.

In the side view shown in FIG. 6(a), music data showing the musical pieces included in each medium are displayed on a corresponding one of the laminated circular cylinders with the music data being categorized according to a specified criterion, such as a music genre, a release date, or a music tone. The user is enabled to cause the data processing device to display a list of musical pieces on a per-category (JAZZ, ROCK, J-POP, . . . ) basis by performing an operation of rotating the laminated circular cylinders in a direction as shown by an arrow in the figure. The example shown in FIG. 6(a) shows that an SD memory “1” is used as a medium placed in an upper layer, and portable audio equipment “2” is used as a medium placed in a lower layer.

In the bottom view shown in FIG. 6(b), the laminated circular cylinders which are viewed from just above or just below are displayed. The example shown in FIG. 6(b) shows that an SD memory “1” is used as a medium placed in the highest layer, discs “2” and “3” are used as media placed in a second layer and in a third layer, and an SD memory “4” is used as a medium placed in the lowest layer. Categorizing of musical pieces showing music data is carried out in the same way as in the case of the side view, and the user is enabled to cause the data processing device to display a list of musical pieces on a per-category basis by performing an operation of rotating the laminated circular cylinders in a direction as shown by an arrow in the figure or in an opposite direction. In this bottom view, the percentage of the number of musical pieces included in each category is expressed by a pie chart.

On the screen of each of the side view and the bottom view, a view switching button 51, a scaling button 52, a categorizing setting button 53, a buy button 54, and a display extraction button 55 are disposed. The view switching button 51 is used in order for the user to cause the data processing device to switch between the side view and the bottom view. More specifically, when the view switching button 51 is pushed down in the state in which the side view is displayed, the data processing device switches to the bottom view, whereas when the view switching button 51 is pushed down in the state in which the bottom view is displayed, the data processing device switches to the side view.

The scaling button 52 is used in order for the user to cause the data processing device to enlarge or reduce the image currently being displayed. The user is enabled to enlarge the image by pushing down a “+” button included in the scaling button 52 while the user is enabled to reduce the image by pushing down a “−” button included in the scaling button 52. The names of musical pieces displayed on each of the laminated circular cylinders are displayed only in a state in which the view is enlarged to such an extent that the characters displayed can be read by the user through the user's operation on the scaling button 52.

The categorizing setting button 53 is used in order for the user to cause the data processing device to open a menu (not shown in the figure) for enabling the user to select a categorizing method to switch to an arbitrary categorizing method. The buy button 54 is used in order for the user to select an arbitrary musical piece from among the musical pieces displayed to purchase the musical piece selected via the Internet.

The display extraction button 55 is used in order for the user to cause the data processing device to extract musical pieces to be displayed on the laminated circular cylinders. The musical pieces extracted through the user's operation on this display extraction button 55 can have three types of display screens (1) to (3) as shown below.

### (1) Display all the Musical Pieces Included in all the Media.

The data processing device extracts and displays the sum-set of the music data included in all the media. All the musical pieces included in all the media are listed with duplicate display of the same musical pieces across two or more media being avoided.

### (2) Display Only the Musical Pieces Commonly Included in all the Media.

The data processing device extracts and displays the product set of the music data included in each of all the media Only the musical pieces commonly included in all the media are displayed.

(3) Display all the Musical Pieces Included in all the Media by Grouping them into Groups Each Including “Related” Musical Pieces which Resemble Each Other.

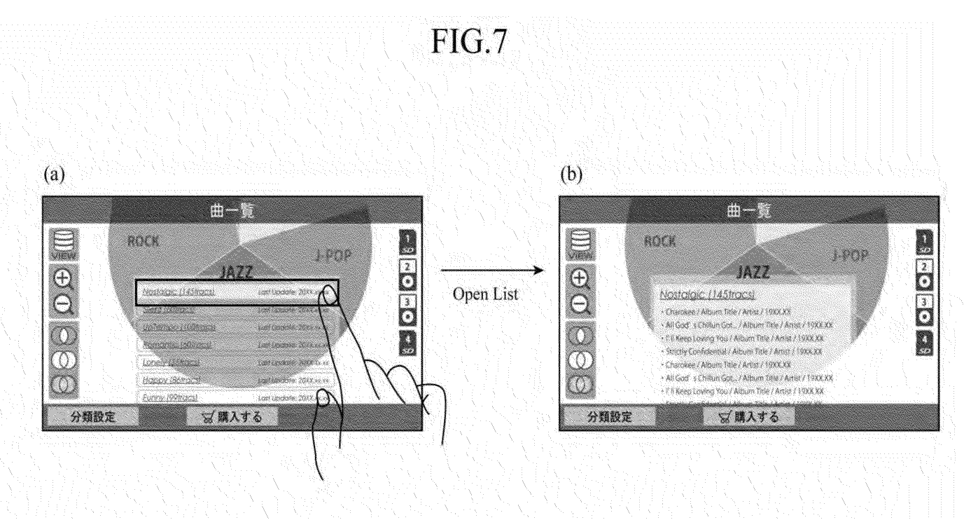

The data processing device extracts musical pieces having a relation, such as “similarity with respect to a certain criterion” or “satisfaction of a certain condition”, from among the plurality of media as each group. Not the name of each musical piece but the name of each group (playlist) extracted (theme or twist) is arranged and displayed. In this case, the criterion or the condition can be specified arbitrarily. More specifically, as shown in FIG. 7(a), when the data processing device groups all the musical pieces included in all the media into a plurality of group names according to a criterion of “melodic similarity”, for example, the user is enabled to specify one of the group names to cause the data processing device to open a list of the group to display all the musical pieces belonging to the group, as shown in FIG. 7(b).

The side view shown in FIG. 6(a) and the bottom view shown in FIG. 6(b) can be configured in such a way that the user can determine in which medium each musical piece is included. For example, the side view and the bottom view can be configured in such away that when the user selects one musical piece, the icon showing the medium in which the musical piece is included lights up or blinks. Further, the side view and the bottom view can be configured in such a way that the icon of the medium in which each musical piece is included is displayed at the right end of the musical piece name.

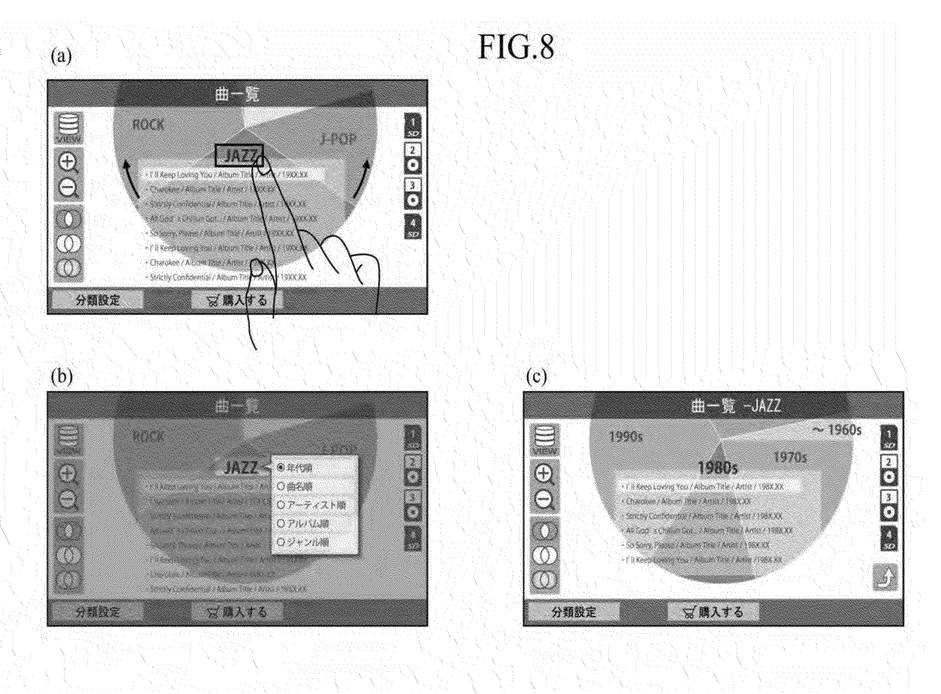

In addition, in order to enable the user to cause the data processing device to perform a more efficient operation on each musical piece group categorized according to the categorizing method selected through the user's operation on the categorizing setting button 53, the data processing device can be constructed in such a way as to carry out the following process. For example, the data processing device can be constructed in such away as to display a sort menu as shown in FIG. 8(b) when the user touches a subject name of “JAZZ” on the screen shown in FIG. 8(a). As a sort criterion for the sort menu, release date, music title, artist name, album title, or genre can be set, for example.

Further, the data processing device can be constructed in such a way as to, when the user touches a subject name of “JAZZ” on the screen shown in FIG. 8(a), display all musical pieces belonging to the subject name by further categorizing them into finer sub-categories according to a criterion such as artist, music genre, release date, or melody. For example, FIG. 8(c) shows an example in which all musical pieces belonging to a subject name are displayed while being categorized into finer sub-categories according to release date. In this case, the view can be configured in such a way that the percentage of the number of musical pieces released during each release date is expressed by a pie chart.

As previously explained, because the data processing device in accordance with Embodiment 1 of the present invention is constructed in such way as to create and display images of a side view and a bottom view of circular cylinders on which music data integrated into the integrated database 12 are displayed, the data processing device can plainly display the music data stored therein.

The data processing device in accordance with above-mentioned Embodiment 1 can be constructed in such a way as to separate a medium which is specified by the user from the plurality of media to enable the user to refer to the musical pieces included in the medium independently. More specifically, when the user would like to divide the plurality of media into some groups to refer to each of these groups, or when the user would like to exclude a medium from the list of musical pieces to which the user desired to refer, the data processing device enables the user to perform an operation of excluding one of the laminated circular cylinders (media) to outside the list to temporarily separate the medium from the list. An operation of excluding a medium and an operation of returning a medium are performed according to the type of view as follows.

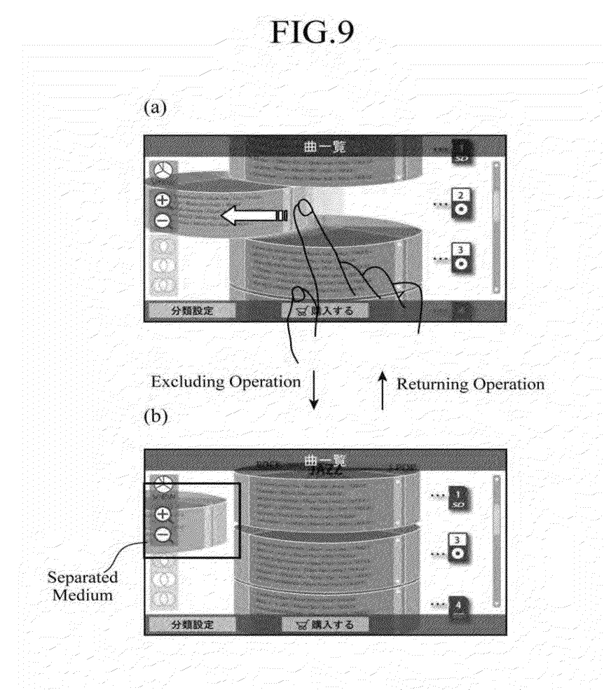

FIG. 9 is a view showing an operation of excluding a medium and an operation of returning a medium on a side view. As shown in FIG. 9(a), when the user performs an operation of hitting one of the laminated circular cylinders toward outside these circular cylinders as if he or she plays a Japanese traditional Daruma Otoshi game, the data processing device separates one corresponding medium to outside the plurality of media, as shown in FIG. 9(b). When the user performs an operation of returning the separated medium in this state, the data processing device returns the side view to its original state, as shown in FIG. 9(a).

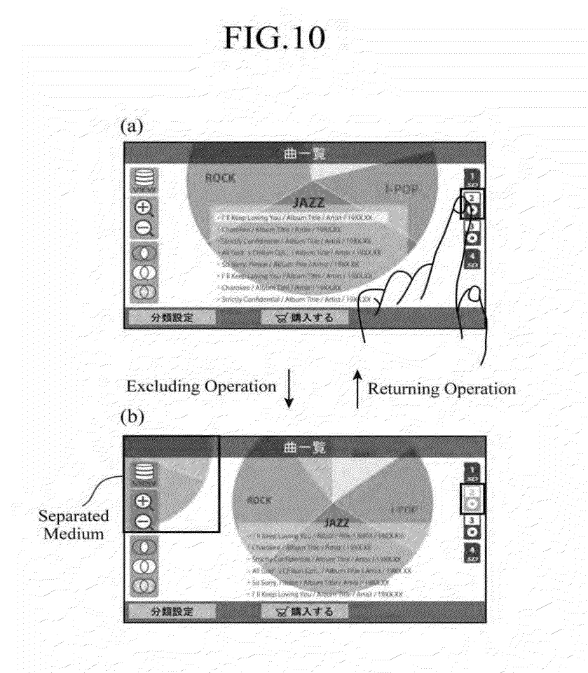

FIG. 10 is a view showing an operation of excluding a medium and an operation of returning a medium on a side view. As shown in FIG. 10(a), when the user touches the icon of a medium, the data processing device separates the medium touched to outside the plurality of media, as shown in FIG. 10(b). In this case, the percentage of the number of musical pieces of each category in the pie chart changes according to the number of musical pieces of each category included in the total number of musical pieces from which the musical pieces included in the separated medium are excluded. In this state, when the user touches the icon of the medium again, the data processing device returns the side view to its original state, as shown in FIG. 10(a).

The data processing device can be constructed in such a way as to, when specifying or determining at least one of a plurality of media for which musical pieces are displayed (in an active state), enable the user to touch and drag the outside of the corresponding circular cylinder to move this specified circular cylinder toward the vicinity of the center of the screen. As a result, the circular cylinder is stuck to the center, and this central circular cylinder is placed in an active state. Further, the data processing device can be constructed in such a way as to enable the user to touch a circular cylinder to specify this circular cylinder. In this case, the data processing device can be constructed in such a way as to display the active circular cylinder in the form of a deep color display, a focus display, a shadow display, or the like.

### Embodiment 2

A data processing device in accordance with Embodiment 2 of the present invention likens one album including music data to a cylinder (circular cylinder).

Assuming that an album is formed in a CD, no tag information is included in the CD while sound source data are recorded in the CD. When a CD is inserted into music database support equipment (i.e. a personal computer or a car navigation device), the data processing device compares the configuration or the like of the sound source data stored in the CD with a music database 10 and acquires tag information about the sound source data, such as music titles. The data processing device links the tag information acquired thereby to the CD, and displays the names of musical pieces stored in the CD or the album name of the CD on a display unit 17. Further, when storing sound source data in a storage area (mainly, a hard disk or a memory) of portable audio equipment or the data processing device, the data processing device stores tag information which the data processing device has acquired previously in a file of the sound source data, or stores the tag information in another file and links this file to the tag information. Therefore, the data processing device can display music titles or other information or can search for a musical piece also for equipment which is not provided with any music database.

The data processing device in accordance with Embodiment 2 of the present invention has the same structure as the data processing device in accordance with Embodiment 1 shown in FIG. 3. Further, the data processing device in accordance with Embodiment 2 of the present invention operates in the same way that the data processing device in accordance with Embodiment 1 shown in FIG. 4 does, with the exception that the data processing device in accordance with Embodiment 2 uses an album instead of each medium.

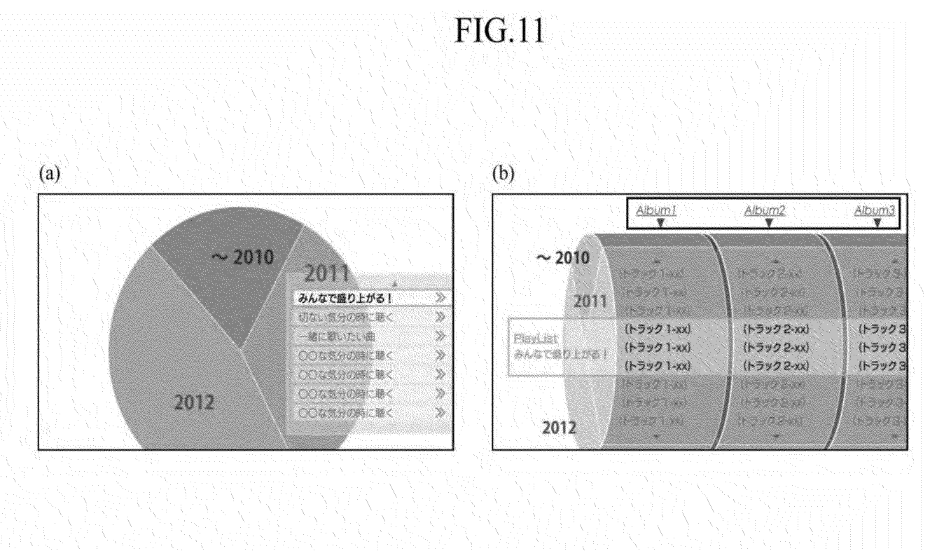

FIG. 11 is a view showing an example of a screen displayed on the display unit 17 in the data processing device in accordance with Embodiment 2. FIG. 11(a) is an example of a bottom view, and FIG. 11(b) is an example of a side view. The side view is displayed in the form of a view in which laminated circular cylinders are lying down horizontally, and “Album1” is assigned to the leftmost layer, “Album2” is assigned to a layer next to the leftmost layer, and “Album3” is assigned to a layer to the right of the second leftmost layer.

The bottom view shown in FIG. 11(a) is displayed in the form of a view in which the circular cylinders placed and laminated in a horizontal direction are viewed from a bottom surface or an upper surface. Because musical pieces which completely match one another hardly exist across a plurality of albums, playlists are produced according to themes or melodies and are displayed.

In the side view shown in FIG. 11(b), on each of the circular cylinders placed and laminated in the horizontal direction, tracks in each of which music data included in the corresponding album are stored are displayed while being categorized into some groups and sorted according to a predetermined criterion, so that the user can refer to each playlist while traversing the plurality of albums. In FIG. 11(b), an example in which musical pieces included in a selected playlist: “Liven up all together!” are listed while being aligned in a horizontal direction on a per-album basis is shown.

As a criterion for categorizing and sorting the musical pieces, genre, artist/album, release date, track title, the number of playback times, degree of favorite, registration or update date, or the like can be used. Further, as a relation between musical pieces included in different media (albums), a full match (shared), similarity in melody or feeling, a person or occurrence in connection with musical pieces, or the like can be used.

### Embodiment 3

A data processing device in accordance with Embodiment 3 of the present invention uses square pillars instead of circular cylinders while handling static image data instead of music data which are handled by the data processing device in accordance with Embodiment 1 or 2. Hereafter, it is assumed that photography data are used as an example of the static image data.

The data processing device in accordance with Embodiment 3 of the present invention has the same structure as the data processing device in accordance with Embodiment 1 shown in FIG. 3. Further, the data processing device in accordance with Embodiment 3 of the present invention operates in the same way that the data processing device in accordance with Embodiment 1 shown in FIG. 4 does, with the exception that the data processing device uses static image data instead of music data.

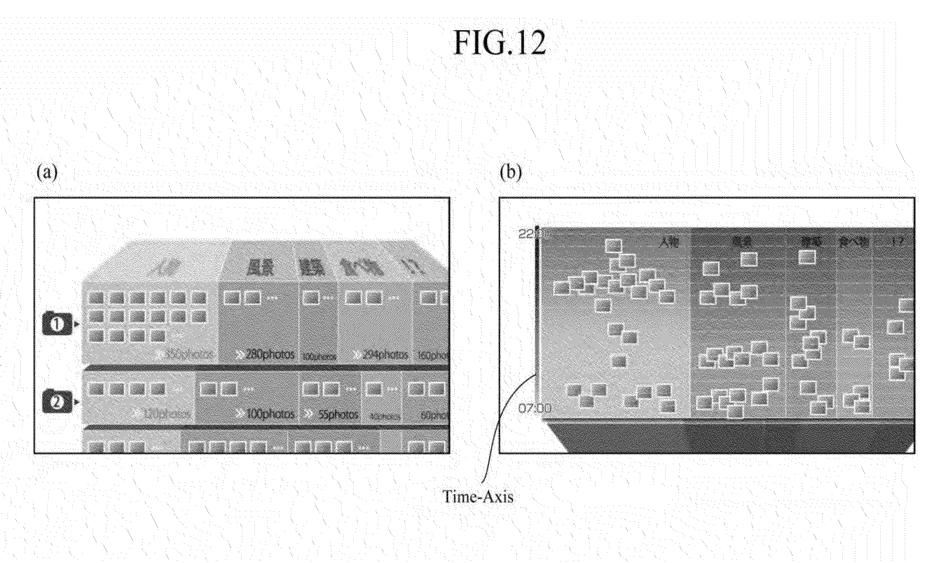

FIG. 12 is a view showing examples of a screen displayed on a display unit 17 in the data processing device in accordance with Embodiment 3. FIG. 12(a) is an example of a side view, and FIG. 12(b) is an example of a bottom view. The side view is displayed not in the form of a view in which laminated square pillars are viewed from just beside, but in the form of a bird's-eye view which laminated square pillars are viewed diagonally from above. Further, the bottom view is displayed not in the form of a view in which laminated square pillars are viewed from just below, but in the form of a bird's-eye view in which laminated square pillars are viewed diagonally from below.

In the side view shown in FIG. 12(a), on each of the laminated square pillars, photography data included in the corresponding medium are displayed while being categorized and sorted according to the types of objects to be shot, such as person, scenery, construction, food, and other objects (!?). The photography data can be configured in such a way that they are displayed as a thumbnail. Further, the percentage of the data volume of each category included in each medium is expressed by a bar graph. In addition, the data volume of each medium is expressed by the thickness of the corresponding square pillar.

In the bottom view shown in FIG. 12(b), the percentage of the data volume of each category across all the media is expressed. Further, the bottom view can show one of various relationships by using a depth direction of each square pillar. For example, when a time-axis is set as the depth direction, the user is enabled to view photographs belonging to the same genre which were taken during the same time period while making a comparison between photographs stored in two or more media.

As a criterion for categorizing and sorting photographs, shooting and update date, shooting and update time, type (person, scenery, building, . . . ), size, filename, or the like can be used. Further, as a relation between photographs included in different media, a full match (shared), a shooting time period, being near in shooting location, similarity in tint or color tone, or the like can be used.

### Embodiment 4

A data processing device in accordance with Embodiment 4 of the present invention handles moving image data instead of music data which are handled by the data processing device in accordance with Embodiment 1 or 2. In this Embodiment 4, it is assumed that data about movies which were shot (referred to as “video data” from here on) are used as an example of the moving image data.

The data processing device in accordance with Embodiment 4 of the present invention has the same structure as the data processing device in accordance with Embodiment 1 shown in FIG. 3. Further, the data processing device in accordance with Embodiment 4 of the present invention operates in the same way that the data processing device in accordance with Embodiment 1 shown in FIG. 4 does, with the exception that moving image data are used instead of music data.

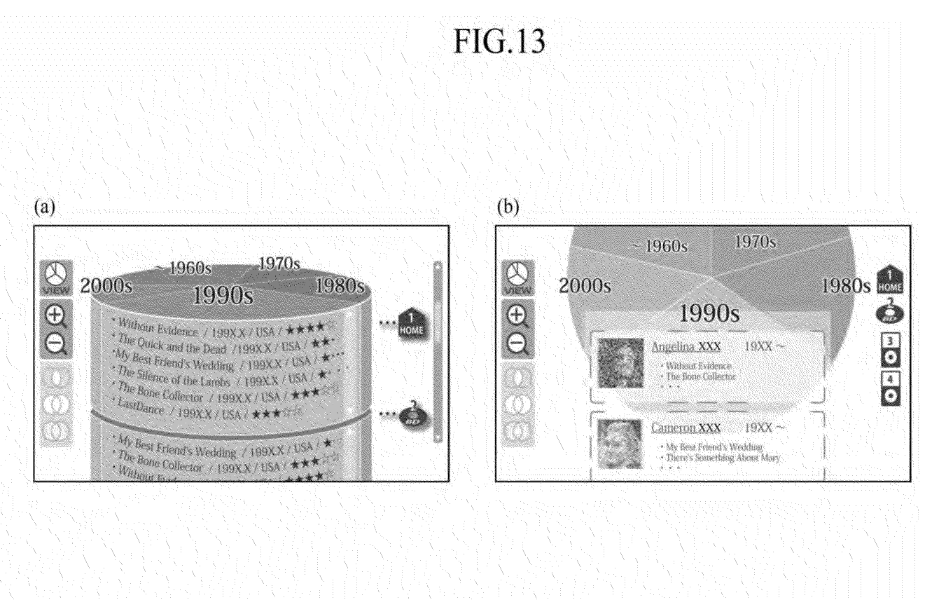

FIG. 13 is a view showing examples of a screen displayed on a display unit 17 in the data processing device in accordance with Embodiment 4. FIG. 13(a) is an example of a side view, and FIG. 13(b) is an example of a bottom view. The side view is displayed in the form of a bird's-eye view in which laminated circular cylinders are viewed diagonally from above, and the bird's-eye angle can be determined arbitrarily. For example, the side view can be displayed in the form of a view which is viewed from just beside.

In the side view shown in FIG. 13(a), on each of the laminated circular cylinders, the moving image data included in the corresponding medium are displayed while being categorized and sorted according to production dates, registration and update dates, types (movie (foreign film, Japanese film, animation, . . . ), TV program, short movie, size, the number of playback times, or filenames. In the example shown in FIG. 13(a), it is shown that a home server “1” is used as a medium placed in an upper layer, and a Blu-ray Disc (BD) “2” is used as a medium placed in a lower layer. When a home server is used as a medium in this way, the data processing device is connected to this home server via communications.

The bottom view shown in FIG. 13(b) is displayed in the form of a view in which laminated circular cylinders are viewed from just above or just below. In the example shown in FIG. 13(b), a case in which a home server “1” is used as a medium placed in the highest layer, a Blu-ray Disc (BD) “2” is used as a medium placed in a second layer, and discs “3” and “4” are used as media placed in a third layer and in a fourth layer. In this case, by grouping the moving image data by performer, the data processing device enables the user to facilitate the use thereof for choosing works that the user's favorite actor appears in while imposing specific conditions on the choosing.

As a relation between moving image data included in different media, a full match (shared), a performer, a producer or/and a director, being near in location, similarity in feeling, similarity in story development, or the like can be used.

### Embodiment 5

A data processing device in accordance with Embodiment 5 of the present invention handles POI data instead of music data which are handled by the data processing device in accordance with Embodiment 1 or 2. In this Embodiment 5, it is assumed that facility data are used as an example of the POI data.

The data processing device in accordance with Embodiment 5 of the present invention has the same structure as the data processing device in accordance with Embodiment 1 shown in FIG. 3. Further, the data processing device in accordance with Embodiment 5 of the present invention operates in the same way that the data processing device in accordance with Embodiment 1 shown in FIG. 4 does, with the exception that facility data are used instead of music data.

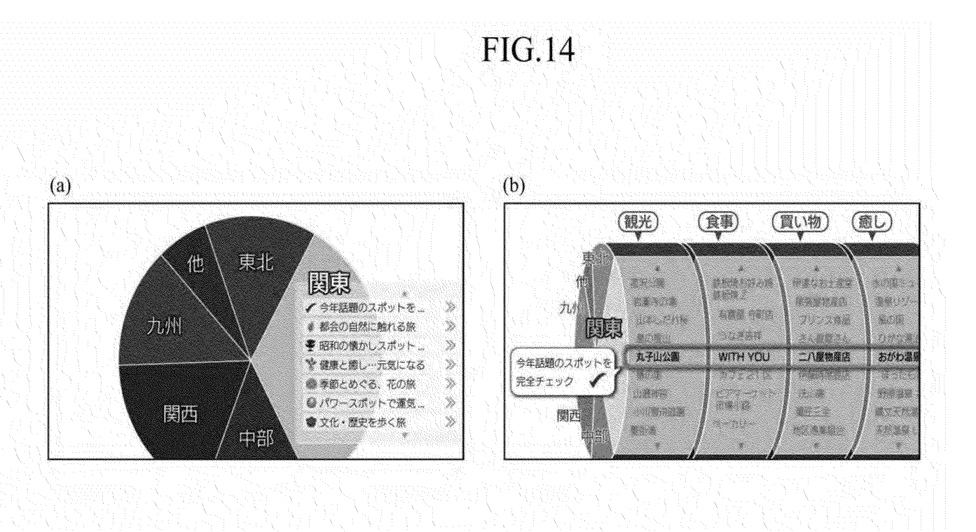

FIG. 14 is a view showing examples of a screen displayed on a display unit 17 in the data processing device in accordance with Embodiment 5. FIG. 14(a) is an example of a bottom view, and FIG. 14(b) is an example of a side view. The side view is displayed in the form of a view in which laminated circular cylinders are lying down horizontally, and facility names are displayed in such a way that facility names associated with “sightseeing” are arranged on the circular cylinder in the leftmost layer, facility names associated with “meal” are arranged on the circular cylinder in the layer next to the leftmost layer, facility names associated with “shopping” are arranged on the circular cylinder in the layer second next to the leftmost layer, and facility names associated with “healing” are arranged on the circular cylinder in the layer third next to the leftmost layer. The order of the display of facility names is suitable for a setup of waypoints according to time, distance, or action pattern in setting up a destination in a car navigation system. For example, the order is one of “sightseeing→having a meal→shopping→going to a hot spring which is a destination”, as shown above. More specifically, when setting up a destination, the car navigation system automatically determines and changes the order in which the data processing device displays facility names, the number of facility names, items, and so on according to a departure time, the destination, and a history of the user's action patterns. For example, when the user has been doing a lot of shopping, and sets a hot spring at a distant place as his or her destination and departs at around noon, the data processing device changes the display of facility names in such a way as to display sightseeing spots on the way to the destination on the circular cylinder in the leftmost layer, information about lunch spots on the circular cylinder in the layer next to the leftmost layer, and information about shopping spots on the circular cylinder in the layer second next to the leftmost layer.

The bottom view shown in FIG. 14(a) is displayed in the form of a view in which circular cylinders placed and laminated in a horizontal direction are viewed from a bottom surface or an upper surface. Because no facilities which completely match one another exist across a plurality of media, playlists of facilities are produced according to themes and are displayed.

In the side view shown in FIG. 14(b), on each of the circular cylinders placed and laminated in the horizontal direction, the names of facilities included in the corresponding medium are displayed while the facilities are categorized into some groups and sorted according to a predetermined criterion, so that the user can refer to a plurality of facilities on a genre-by-genre basis. In FIG. 14(b), an example in which facilities included in a selected playlist: “ . . . spots most talked about this year” are listed while being aligned in a horizontal direction on a per-genre basis is shown. The data processing device can also be constructed in such a way as to enable the user to set one of the listed facilities as his or her destination, and make a route setting.

As a criterion for categorizing and sorting, region, distance from the current position or the destination, date on which facility was constructed, registration or update date, or the like can be used. Further, as a relation between data included in different media, a full match (shared), a theme, the name of a TV program or a magazine on which facilities were reviewed, a historical background, a celebrity in connection with facilities, or the like can be used. Further, when the cylinders are grouped by facility genre, as a relation between facilities included in different genres, a theme, the name of a TV program or a magazine on which facilities were reviewed, a historical background, a celebrity in connection with facilities, or the like can be used.

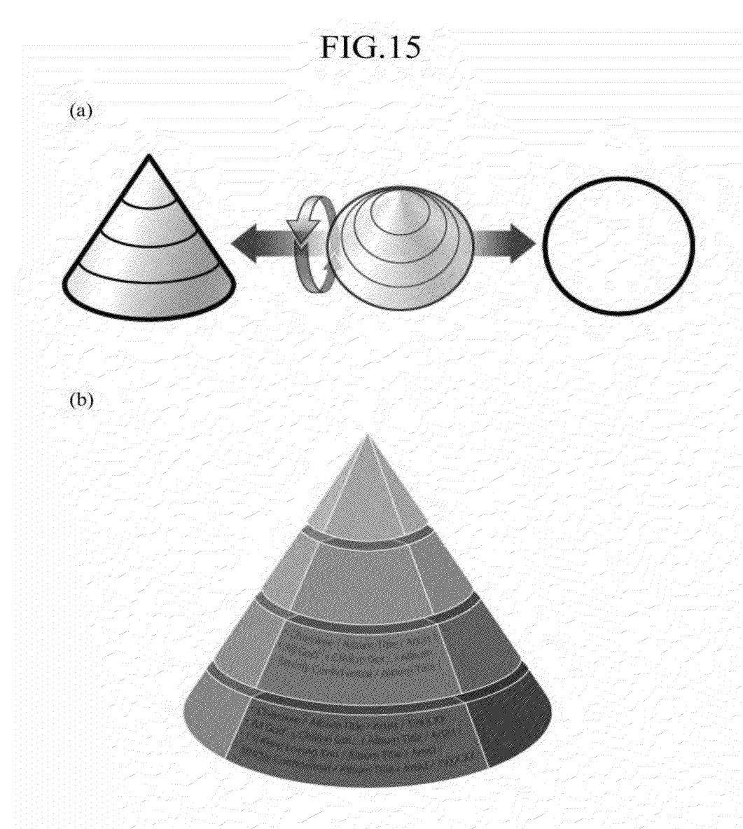

In the data processing device in accordance with any one of Embodiments 1 to 5 explained above, a circular cylinder or a square pillar is used as each cylinder for expressing data. As an alternative, a cone as shown in FIG. 15 can be used as each cylinder. In this case, the data processing device rotates the cone in a direction shown by an arrow of FIG. 15(a) to create a side view and a bottom view. FIG. 15(b) is a view showing an example in which data are expressed by the side view. This structure is effective for a case in which weights are assigned to data searched for. For example, by displaying the information in such a way that information having a higher degree of importance for the user, such as musical pieces which the user frequently listens to or musical pieces of a favorite genre, is arranged in a higher portion of the cone, the data processing device enables the user to immediately find out a set of musical pieces to which the user desires to listen to cause a playback device to play back the set of musical pieces.

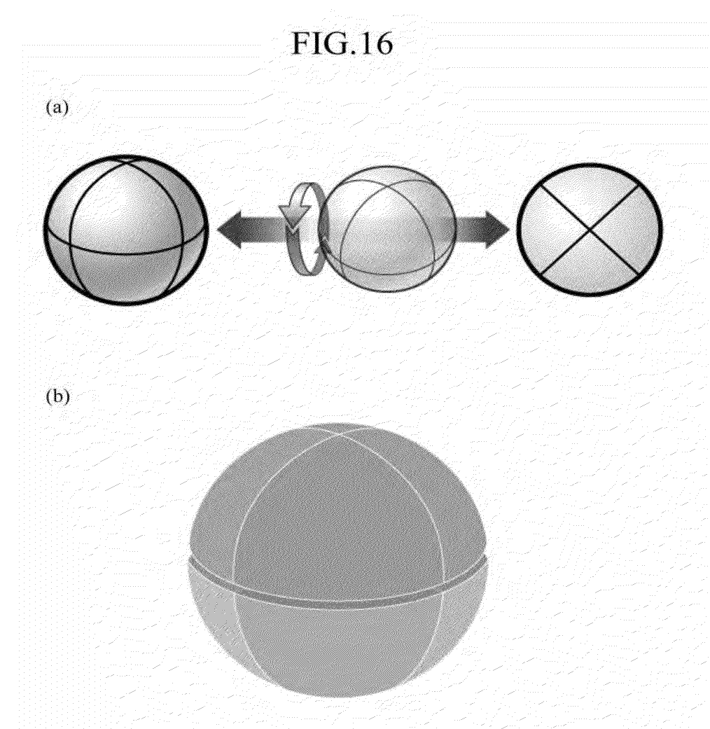

Further, as each cylinder for expressing data, a solid sphere as shown in FIG. 16 can also be used. In this case, by rotating the solid sphere in a direction shown by an arrow of FIG. 16(a), the data processing device creates a side view and a bottom view. FIG. 16(b) is a view showing an example in which the side view expresses data. In this structure, by distributing the data on the solid sphere in the form of a globe from the viewpoint of the world in such a way that photographs of sightseeing spots are intuitively arranged on a world map, the data processing device improves the at-a-glance visibility of searched data, thereby enabling the user to search for desired search data efficiently.

### INDUSTRIAL APPLICABILITY

The present invention can be used for a car navigation system which displays musical pieces, still images, moving images, or facility information in such a way that the user can easily select a musical piece, a still image, a moving image, or a facility, a program guide for a television set or a recorder, a guiding system for town, etc.

1. A data processing device comprising:
a data acquisition unit for acquiring data from outside the data processing device;
an integrated database for integrating the data acquired by said data acquisition unit thereinto;
a data analysis determination unit for analyzing the data integrated into said integrated database, and for categorizing the data according to a specified criterion to construct a data set expressed by a solid;
a display control unit for creating an image of a side view of and an image of a bottom view of the solid expressing the data integrated into said integrated database on a basis of said data set constructed by said data analysis determination unit and said data; and
a display unit for displaying the images created by said display control unit.

2. The data processing device according to claim 1, wherein the solid which is used for both the images of the side view and the bottom view created by the display control unit is one of a cylinder, a square pillar, a cone, and a solid sphere.

3. The data processing device according to claim 1, wherein the data acquired by the data acquisition unit are comprised of music data, and the display control unit creates the image of the side view of and the image of the bottom view of the solid expressing the music data integrated into said integrated database on a basis of the analysis result acquired by said data analysis determination unit and said music data.

4. The data processing device according to claim 1, wherein the data acquired by the data acquisition unit are comprised of music data including sound source data contained in an album, and the display control unit creates the image of the side view of and the image of the bottom view of the solid expressing the album on a basis of the analysis result acquired by said data analysis determination unit and the music data integrated into said integrated database.

5. The data processing device according to claim 1, wherein the data acquired by the data acquisition unit are comprised of static image data.

6. The data processing device according to claim 1, wherein the data acquired by the data acquisition unit are comprised of moving image data.

7. The data processing device according to claim 1, wherein the data acquired by the data acquisition unit are comprised of facility information data.
